(19) United States
(12) Patent Application Publication
(10) Pub. No.: US 2025/0308555 A1
(43) Pub. Date: Oct. 2, 2025

(54) TAPE GUIDE ASSEMBLY

(71) Applicant: International Business Machines Corporation, Armonk, NY (US)

(72) Inventors: Mark Alfred Lantz, Adliswil (CH); Hugo E. Rothuizen, Oberrieden (CH); Simeon Furrer, Altdorf (CH); Beat Eugen Weiss, Edlibach (CH); Stella Brach, Oberrieden (CH); Luzius Kronig, Zurich (CH)

(21) Appl. No.: 18/616,915

(22) Filed: Mar. 26, 2024

(51) Int. Cl. G11B 15/62; G11B 5/008

(52) U.S. Cl. CPC G11B 15/62; G11B 5/00813

(57) ABSTRACT

A tape head module and tape guide assembly. The assembly includes a tape head module that is adapted for reading data from tape or writing data to the tape. The assembly further includes a first tape support guide and a second tape support guide that are positioned on opposite sides of the tape head module and in close proximity to the tape head module and adapted to provide a short and stiff portion of the tape located near the tape head module and provide a stable interface between the tape head module and the tape.

### BACKGROUND

The present disclosure generally relates to data storage systems and, more particularly, to tape-based storage systems and components thereof.

In certain computing systems, tape-based storage systems include a tape drive and tape cartridges or cassettes that store tape media (also called tape film or magnetic tape). The tape drive performs writing or reading of data in the cartridges or cassettes.

### SUMMARY

According to some embodiments of the disclosure, there is provided a tape head module and tape guide assembly. The assembly includes a tape head module that is adapted for reading data from tape or writing data to the tape. The assembly further includes a first tape support guide and a second tape support guide that are positioned on opposite sides of the tape head module and in close proximity to the tape head module and adapted to provide a short and stiff portion of the tape located near the tape head module and provide a stable interface between the tape head module and the tape.

According to some embodiments of the disclosure, there is provided a tape head module and tape guide assembly. The assembly includes a tape head module that is adapted for reading data from tape or writing data to the tape. The assembly further includes a first tape support guide and a second tape support guide that are positioned on an opposite side of the tape from the tape head module and in close proximity to each other and adapted to provide a short and stiff portion of the tape located near the tape head module and provide a stable interface between the tape head module and the tape.

According to some embodiments of the disclosure, there is provided a tape drive system. The system including a tape media adapted to store data, at least one reel adapted to unroll the tape media therefrom or roll the tape media thereto, and a tape head module and tape guide assembly for reading from or writing to the tape media. The assembly includes a tape head module adapted for reading data from the tape media or writing data to the tape media, and a first tape support guide and a second tape support guide that are positioned on opposite sides of the tape head module and in close proximity to the tape head module and adapted to provide a short and stiff portion of the tape media located near the tape head module and provide a stable interface between the tape head module and the tape media. The system further includes a plurality of rollers rotatable about an axis and adapted to move the tape media past the tape head module and tape guide assembly.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a top view of a tape drive of a tape-based data storage system, in accordance with an embodiment of the disclosure.

FIG. 2 illustrates a side view of a portion of the tape drive of FIG. 1 taken at 2-2 in FIG. 1, in accordance with an embodiment of the disclosure.

FIG. 3 illustrates a top view of a tape head module and tape guide assembly of a portion of a tape drive of a tape-based data storage system, in accordance with an embodiment of the disclosure.

FIG. 4 illustrates a side view of the tape head module and tape guide assembly of FIG. 3 taken at 4-4, in accordance with an embodiment of the disclosure.

FIG. 5 illustrates a top view of a portion of a tape drive including a tape guide assembly of a tape-based data storage system, in accordance with an embodiment of the disclosure.

FIG. 6 illustrates a side view of the portion of the tape drive of FIG. 5 taken at 6-6, in accordance with an embodiment of the disclosure.

FIG. 7 illustrates perspective views of examples of guides, in accordance with an embodiment of the disclosure.

FIG. 8 illustrates a top view of a portion of a tape drive including a tape guide assembly of a tape-based data storage system, in accordance with an embodiment of the disclosure.

FIG. 9 is a flow diagram of a method, in accordance with an embodiment of the disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

It will be readily understood that the components of the present embodiments, as generally described and illustrated in the Figures herein, can be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment. It should be understood that the various embodiments can be combined with one another, and that any one embodiment can be used to modify another embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

It is to be understood that the present disclosure will be described in terms of a given illustrative architecture; however, other architectures, structures, and process features and steps/blocks can be varied within the scope of the present disclosure. It should be noted that certain features cannot be shown in all figures for the sake of clarity. This is not intended to be interpreted as a limitation of any particular embodiment, or illustration, or scope of the claims.

Computing systems process and record data. Large volumes of data are often stored or transferred to nonvolatile storage media, such as magnetic tape cartridges, for example. Typically, magnetic tape is the most economical, convenient, and secure means of storing or archiving data.

Track density of magnetic tape is the number of data tracks per inch (TPI) in the transverse direction of the tape. Track density is calculated by taking an inverse of track pitch (i.e., the distance between adjacent tracks). Compared to hard disk, the track density of tape is lower by a factor of 12 to 25. This has been necessitated by the challenges associated with track following on a flexible tape substrate and a combination of the dimensional instability of the tape substrate and the multi-track recording, which place additional tolerance requirements on tape. Track density improvement has been identified as an area with potential leverage for advancing tape technology.

Track density scaling can be limited by a track following performance of a magnetic tape head module assembly. It is desirable for the magnetic tape head to be as light as possible such that the track following controller bandwidth can be increased and hence follow and correct for high frequency disturbances. Another issue limiting track density scaling can be friction between the magnetic tape head module assembly and tape, which can induce disturbances such as compression waves.

Track density scaling is currently a main driver of tape capacity scaling and is expected to remain so for the foreseeable future. Minimizing tape head module mass and friction becomes increasingly important with each new generation of tape drive that is expected to operate with further reduced track pitch.

Aspects of the present disclosure relate generally to a tape-based storage system. More particularly, the present disclosure provides a tape guide assembly. The tape guide assembly can either include, or be used in conjunction with, a tape head module adapted for reading and writing data to tape. The tape head module spans only a fraction of a width of the tape. The tape is supported by the tape guide assembly using tape guides, such as guideposts or rollers, which are located in close proximity to the tape head module. The tape guide assembly can use either front side guiding or back side guiding. Front side guiding involves the tape guides and the tape head module being on the same side of the tape. Back side guiding involves the tape guides and the tape head module being on opposite sides of the tape. While the present disclosure is not necessarily limited to such applications, various aspects of the disclosure can be appreciated through a discussion of various examples using this context.

Embodiments of the present disclosure can include two tape guides (i.e., guideposts or rollers) that are positioned immediately before and after a tape head module and on the same side of tape as the tape head module in order to ensure that the tape is adequately supported as it passes over the tape head module.

Embodiments of the present disclosure can include two tape guides (i.e., guideposts or rollers) that are positioned on an opposite side of tape from a tape head in order to ensure that the tape is adequately supported as it passes over the tape head module.

Embodiments of the present disclosure can include two tape guides (i.e., guideposts or rollers) that are positioned a close distance apart in order to ensure that the tape is adequately supported as it passes over the tape head module. The close distance can be between about 0.1 millimeters and 1.0 millimeters, for example.

Embodiments of the present disclosure include tape guides that can be guideposts or rollers. Guideposts can be used, for example, with front side guiding, and rollers can be used, for example, with back side guiding. When guideposts are used, which are stationary, as the tape begins to move, the tape can stick to the guideposts. After some delay, when the tape begins to move over the guideposts, an air bearing can be created. An air bearing can result in minimal friction between the tape and the guideposts. Since the guideposts are narrower than the rollers, the guideposts can take up less space, and can be placed closer to the tape head module in order to support the tape over the tape head module. When rollers are used, which include bearings that allow them to spin, an air bearing can also result if the rollers include a smooth surface in contact with the tape. As the smooth rollers begin to spin, the tape can drag air along, thereby creating an air bearing(s) after start-up. The rollers can instead include a plurality of grooves, which can advantageously inhibit the creation of an air bearing after start-up of the grooved rollers.

Embodiments of the present disclosure can include a tape head module that does not laterally cover a full width of the tape. A smaller, or “mini,” tape head module can be used, which can advantageously reduce tape head module friction and mass.

Embodiments of the present disclosure can provide advantages that can be valuable to the data storage industry. Track density scaling is currently a main driver of tape capacity scaling and is expected to remain so for the foreseeable future in tape-based data storage systems. Minimizing tape head module mass and friction becomes increasingly important with each new generation of tape drive that is expected to operate with further reduced track pitch. Track pitch is the distance between adjacent tracks on a magnetic surface, as measured from the center of one track to the center of another track. The term “adjacent channels” refers to adjacent reader or writer transducers in the tape head module, which are much farther apart than adjacent tracks written on the tape. The track pitch determines the track density, which is the number of tracks per inch.

Embodiments of the present disclosure can advantageously reduce both tape head module assembly mass and tape head module assembly friction. The size of the tape head module can be reduced due to the guides enabling the tape to extend across and contact the tape head module in order for effective reading or writing from or to the tape, respectively.

Embodiments of the present disclosure can advantageously include a tape head module that has reduced friction between the tape head module and tape, which can result from the tape head module not spanning the whole width of the tape.

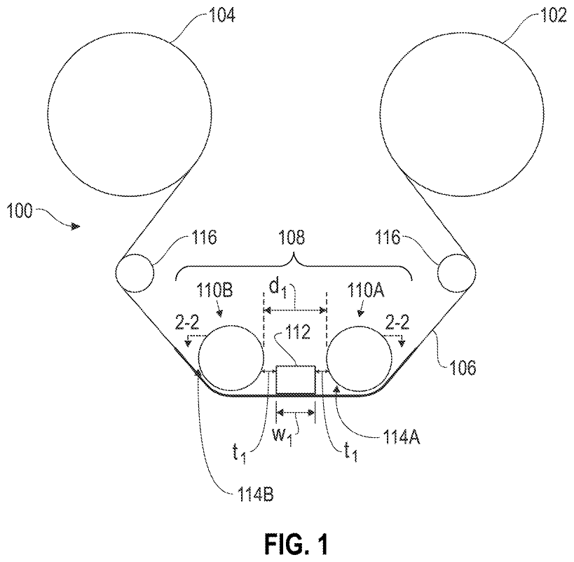

FIG. 1 illustrates a top view of a tape drive 100 of a tape-based data storage system, in accordance with an embodiment of the disclosure. While one specific implementation of a tape drive is shown in FIG. 1, it should be noted that the embodiments described herein can be implemented in the context of any suitable type of a tape drive system and the possible tape drive systems are not limited to the one shown in FIG. 1 and described herein.

As shown in FIG. 1, a tape supply cartridge 102 (or reel) and a take-up reel 104 are provided to support a tape 106 (or “tape media”) and provide or take up the tape 106 in the tape drive 100. The tape drive 100 can include at least one reel adapted to unroll the tape therefrom (like tape supply cartridge 102) or roll the tape media thereto (like take-up reel 104). One or more of the reels can alternatively form part of a removable cassette and are not necessarily part of the tape drive 100. The tape drive 100, such as that illustrated in FIG. 1, can further include drive motor(s) to drive the tape supply cartridge 102 and the take-up reel 104 to move the tape 106 through a tape head module and tape guide assembly 108 (or “tape head and tape guide assembly”), which is part of the tape drive 100. The tape 106 can be moved in either direction.

The tape head module and tape guide assembly 108, of the tape drive 100, includes front side guiding. The tape head module and tape guide assembly 108 can include a first guide 110A (or “first tape support guide”) and a second guide 110B (or “second tape support guide”) that can be located on either side of a tape head module 112 (or “tape head”). The first and second guides 110A, 110B can be rollers, as shown, or any other suitable part that can guide the tape 106 over the tape head module 112. The first and second guides 110A, 110B as rollers can include a cylinder that surrounds a shaft that includes bearings between the shaft and the cylinder that allows the cylinder to spin around the shaft and allow tape to move on the cylinder of the rollers. If the first and second guides 110A, 110B are rollers, such as those shown in FIG. 1, the rollers can have a smooth surface on the cylinder that contacts the tape, or the surface that contacts the tape can include a plurality of grooves, for example. The presence of the plurality of grooves can prevent creation of an air bearing after start-up of motion of the tape.

The first guide 110A and the second guide 110B guide can support the tape 106 as it moves across the tape head module 112. The location of the first guide 110A and the second guide 110B can be precisely set relative to the location of the tape head module 112. The tape 106 can move in both directions. The first guide 110A and the second guide 110B can be positioned closely to the tape head module 112 in order to ensure a short or stiff span of the tape 106 that can achieve a stable interface between the tape head module 112 and the tape 106.

A first air bearing 114A and a second air bearing 114B can form between the first guide 110A and the second guide 110B, respectively, and the tape 106 during tape 106 transport. The first air bearing 114A and a second air bearing 114B may form when the tape 106 is transported across the curved surfaces of the first guide 110A and the second guide 110B. The first guide 110A and the second guide 110B, as shown, are smooth rollers, which can result in air bearing formation during tape transport. When the tape 106 is not moving but is under tension, the tape 106 can contact the first guide 110A and the second guide 110B over a region determined by the diameters (or radii of the first guide 110A and the second guide 110B, respectively, and the wrap angle of the tape 106 around the first guide 110A and the second guide 110B, respectively. When the tape 106 is in motion, the first air bearing 114A and the second air bearing 114B can form between the tape 106 and the first guide 110A and the second guide 110B in the region that was previously in contact. If other suitable guides besides smooth rollers are used, such as grooved rollers, for example, air bearings may not form or may be reduced. The first air bearing 114A and the second air bearing 114B can result in a reduction of friction between the tape 106 and the first guide 110A and the second guide 110B, respectively.

A number of additional rollers 116 can be included in the tape drive 100 in order to move the tape 106 through the tape head module and tape guide assembly 108. The additional rollers 116 can be rotatable about an axis and adapted to move the tape 106 past the tape head module and tape guide assembly 108. The two (2) additional rollers 116 shown are an example, and other numbers and configurations of the additional rollers 116 are also contemplated.

The tape head module and tape guide assembly 108 is designed in order to minimize spacing between the tape head module 112 and the tape 106. The first guide 110A and the second guide 110B can minimize the spacing between the tape 106 and the tape head module 112 by providing a wrap angle of the tape 106 over the tape head module 112 in a range of 0.1 to 1.0 degrees, for example. The tape head module and tape guide assembly 108 is also designed in order to minimize the mass (i.e., size) of the tape head module 112 and minimize the friction between the tape 106 and the tape head module 112.

The first guide 110A and the second guide 110B can be positioned closely to the tape head module 112 in order to ensure a short and stiff span of the tape 106 to achieve a stable interface between the tape 106 and the tape head module 112. The tape head module 112 can be located a distance away from the first guide 110A and the second guide 110B, which can be called a “tolerance” (t₁). The tolerance is a space between the first guide 110A or the second guide 110B and the tape head module 112. As shown, d₁ is the distance between the first guide 110A and the second guide 110B. w₁ is the width of the tape head module 112. In the embodiment shown:

d₁=w₁+2t₁ (1)

In one embodiment, t₁ can be in a range of 0.1 mm to 1.0 mm. In another embodiment, t₁ can be in a range of 0.1 mm to 0.5 mm.

In one embodiment, a radius of each of the first guide 110A and the second guide 110B can be in the range of 10-20 millimeters (mm). In another embodiment, the radius of each of the first guide 110A and the second guide 110B can be in the range of 10-12 mm. Other suitable radii are also contemplated, however.

The tape head module 112 can be, for example, a magnetic tape head module that can include a plurality of arrays of data transducers. The tape head module 112 can be any suitable device that can read and/or write on tape media. The tape head module 112 (or “head” or “tape head” or “mini tape head module” or “mini module”) can contain one or more write transducers used in tape recorders that can convert electrical signals to magnetic ones and one or more read transducers that can convert magnetic signals to electrical signals. The tape head module 112 can include, for example, three head modules, including two write transducer modules and one read transducer modules. Each of these modules can contain one or more transducers.

The tape drive 100 as shown can include a single reel cartridge, such as the tape supply cartridge 102, and a take-up reel, such as the take-up reel 104, in the tape drive 100. The tape drive 100 can use precisely controlled motors to wind the tape 106 from one reel to the other, passing the tape head module 112 as it does. In the tape drive 100, the tape 106 can be moved over a surface of the tape head module 112 at a high speed.

The tape drive 100 can include other components that are not shown. For example, the tape head module 112 can be coupled to a controller. The controller can be or include a processor and/or any logic for controlling any subsystem of the tape drive 100. For example, the controller can control functions of the tape head module 112 such as servo following, data writing, data reading, etc. The controller can operate under logic known in the art. The controller can be coupled to a memory of any known type, which can store instruction executable by the controller. Moreover, the controller can be configured and/or programmable to perform or control any desired methodology.

The tape-based data storage system that can include the tape drive 100 can include other components as well. For example, the tape-based data storage system can include an interface (not shown). The interface can be provided for communication between the tape drive 100 and a host (integral or external) to send and receive data and for controlling the operation of the tape drive 100 and communicating the status of the tape drive 100 to the host.

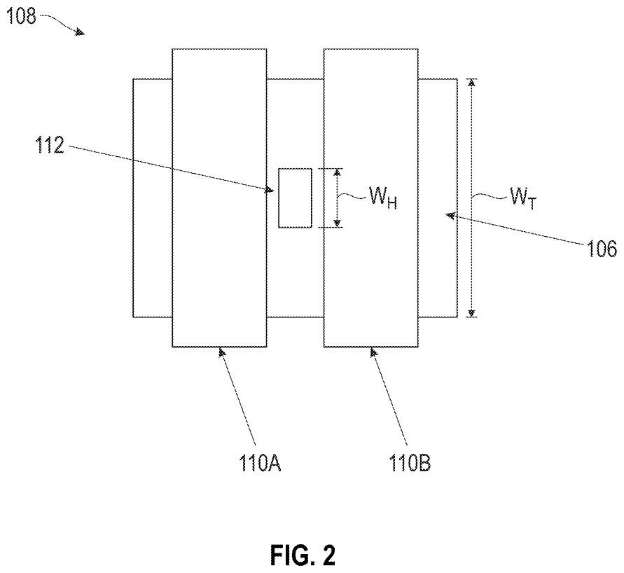

FIG. 2 illustrates a side view of a portion of the tape drive 100 of FIG. 1 taken at 2-2 in FIG. 1, in accordance with an embodiment of the disclosure. The tape head module 112 is narrower than the width of the tape 106. As shown, the tape 106 has a width indicated by W_{T}. The tape head module 112 has a width, indicated by W_{H}. In one embodiment, the ratio of the width of the tape head module 112 to the width of the tape 106 can be less than 1, or in a range from about 0.14 to about 0.55. W_{H} is less than W_{T}.

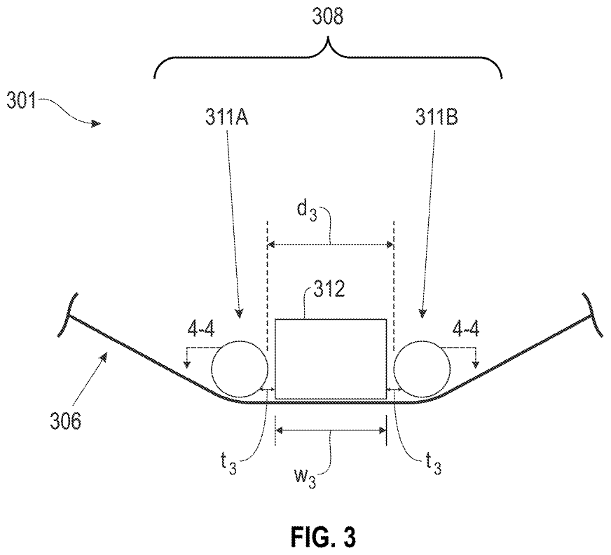

FIG. 3 illustrates a top view of a tape head module and tape guide assembly 308 (or “tape head and tape guide assembly”) of a portion of a tape drive 301 of a tape-based data storage system, in accordance with an embodiment of the disclosure. The tape head module and tape guide assembly 308 can include a first guide 311A (or “first tape support guide”) and a second guide 311B (or “second tape support guide”) that can be located on either side of a tape head module 312 (or “tape head”). The tape head module 312 can contain one or more write transducers used in tape recorders that can convert electrical signals to magnetic ones and one or more read transducers that can convert magnetic signals to electrical ones. The first and second guides 311A, 311B can be guideposts, as shown, which are stationary parts that include a curved surface to guide a tape 306 (or “tape media”) over the tape head module 312. The guideposts can be a smooth, polished cylinder that is stationary, such as those shown in FIG. 3. Other cross-sectional shapes of the guideposts shown are contemplated by the present disclosure to be used as guides. A suitable shape that includes a curved surface for the tape 306 to move across can also be shaped in order to be placed in close proximity to the tape head module 312.

The tape head module and tape guide assembly 308 includes front side guiding. The first guide 311A and the second guide 311B guide can support the tape 306 as it moves across the tape head module 312. The location of the first guide 311A and the second guide 311B can be precisely set relative to the location of the tape head module 312. The tape 306 can move in either direction as it moves over the tape head module 312. The first guide 311A and the second guide 311B can be positioned closely to the tape head module 312 in order to ensure a short or stiff span of the tape 306 that can achieve a stable interface between the tape head module 312 and the tape 306.

The tape head module and tape guide assembly 308 is designed in order to minimize spacing between the tape head module 312 and the tape 306. The first guide 311A and the second guide 311B can minimize the spacing between the tape 306 and the tape head module 312 by providing a wrap angle of the tape 306 over the tape head module 312 in a range of 0.1 to 1.0 degrees, for example. The tape head module and tape guide assembly 308 is also designed in order to minimize the mass of the tape head module 312 and minimize the friction between the tape 306 and the tape head module 312.

The first guide 311A and the second guide 311B can be positioned closely to the tape head module 312 in order to ensure a short and stiff span of the tape 306 to achieve a stable interface between the tape 306 and the tape head module 312. The tape head module 312 can be located a distance away from the first guide 311A and the second guide 3111B, which can be called a “tolerance” (t₃). The tolerance is a space between the first guide 311A or the second guide 311B and the tape head module 312. As shown, d₃ is the distance between the first guide 311A and the second guide 311B. w₃ is the width of the tape head module 312. In the embodiment shown:

d₃=w₃+2t₃ (2)

In one embodiment, t₃ can be in a range of 0.1 mm to 1.0 mm. In another embodiment, t₃ can be in a range of 0.1 mm to 0.5 mm.

In one embodiment, a radius of each of the first guide 311A and the second guide 311B can be in the range of 0.5 to 4 millimeters (mm). Other suitable radii are also contemplated, however.

The tape head module 312 can be, for example, a magnetic tape head module that can include a plurality of arrays of data transducers. The tape head module 312 can be any suitable device that can read and/or write on tape media. The tape head module 312 (or “head” or “tape head” or “mini tape head module” or “mini module”) can contain one or more write transducers used in tape recorders that can convert electrical signals to magnetic ones and one or more read transducers that can convert magnetic signals to electrical signals. The tape head module 312 can include, for example, three head modules, including two write transducer modules and one read transducer module. Each of these modules can contain one or more transducers.

The portion of the tape drive 301 as shown can be connected to other components (that are not shown), for example, such as those described with regard to the tape drive 100 in FIG. 1. The tape drive 100 in FIG. 1 is just one example, however, and other suitable tape drives are also contemplated by the present disclosure.

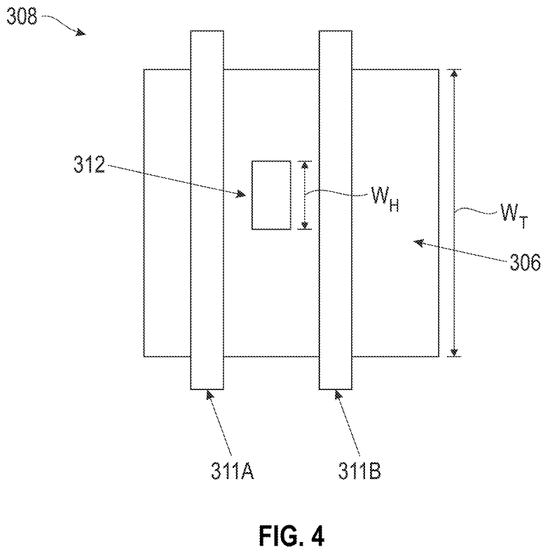

FIG. 4 illustrates a side view of the tape head module and tape guide assembly 308 of FIG. 3 taken at 4-4, in accordance with an embodiment of the disclosure. The tape head module 312 is narrower than the width of the tape 306. As shown, the tape 306 has a width indicated by W_{T}. The tape head module 312 has a width, indicated by W_{H}. In one embodiment, the ratio of the width of the tape head module 312 to the width of the tape 306 can be less than 1, or in a range from about 0.14 to about 0.55. W_{H} is less than W_{T}.

The tape head module 312 can be located a distance away from the first guide 311A and the second guide 311B. The first guide 311A and the second guide 311B can be positioned closely to the tape head module 312 in order to ensure a short and stiff span of the tape 306 to achieve a stable interface between the tape 306 and the tape head module 312.

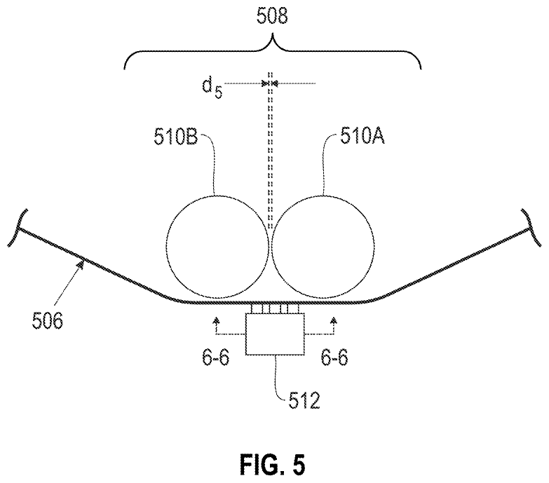

FIG. 5 illustrates a top view of a tape head module and tape guide assembly 508 (or “tape head and tape guide assembly”) of a portion of a tape drive 501 of a tape-based data storage system, in accordance with an embodiment of the disclosure. The tape head module and tape guide assembly 508 can include a first guide 510A (or “first tape support guide”) and a second guide 510B (or “second tape support guide”) that can be located on an opposite side of a tape 506 (or “tape media”) from a tape head module 512 (or “tape head”). The tape head module and tape guide assembly 508 includes back side guiding. The tape head module 512 can contain one or more write transducers used in tape recorders that can convert electrical signals to magnetic ones and one or more read transducers that can convert magnetic signals to electrical ones. The first and second guides 510A, 510B can be rollers, as shown, or any other suitable part that can guide the tape 506 over the tape head module 512.

The first guide 510A and the second guide 510B guide can support the tape 506 as it moves across the tape head module 512. The location of the first guide 510A and the second guide 510B can be set closer together than in the previous embodiments shown in FIGS. 1-4 because the tape head module 512 is on an opposite side of the tape 506 from the first guide 510A and the second guide 510B. The tape 506 can move in either direction as it moves over the tape head module 512. The first guide 510A and the second guide 510B can be positioned closely to the tape head module 512 in order to ensure a short or stiff span of the tape 506 that can achieve a stable interface between the tape head module 512 and the tape 506.

The tape head module and tape guide assembly 508 is designed in order to minimize spacing between the tape head module 512 and the tape 506. The first guide 510A and the second guide 510B can minimize the spacing between the tape 506 and the tape head module 512 by providing a wrap angle of the tape 506 over the tape head module 512 in a range of 0.1 to 1.0 degrees, for example. The tape head module and tape guide assembly 508 is also designed in order to minimize the mass of the tape head module 512 and minimize the friction between the tape 506 and the tape head module 512.

The first guide 510A and the second guide 510B can be positioned to each other in order to ensure a short and stiff span of the tape 506 to achieve a stable interface between the tape 506 and the tape head module 512. As shown, d₅ is the distance between the first guide 510A and the second guide 510B. In one embodiment, d₈ can be in a range of 0.1 mm to 2.0 mm. In another embodiment, d₅ can be in a range of 0.1 mm to 1.0 mm.

In one embodiment, a radius of each of the first guide 510A and the second guide 510B can be in the range of 5-10 millimeters (mm). In another embodiment, the radius of each of the first guide 110A and the second guide 110B can be in the range of 5-6 mm. Other suitable radii are also contemplated, however.

The tape head module 512 can be, for example, a magnetic tape head module that can include a plurality of arrays of data transducers. The tape head module 512 can be any suitable device that can read and/or write on tape media. The tape head module 512 (or “head” or “tape head” or “mini tape head module” or “mini module”) can contain one or more write transducers used in tape recorders that can convert electrical signals to magnetic ones and one or more read transducers that can convert magnetic signals to electrical signals. The tape head module 512 can include, for example, three transducers, including two write transducers and one read transducer.

The portion of the tape drive 501 as shown can be connected to other components (that are not shown), for example, such as those described with regard to the tape drive 100 in FIG. 1. The tape drive 100 in FIG. 1 is just one example, however, and other suitable tape drives are also contemplated by the present disclosure.

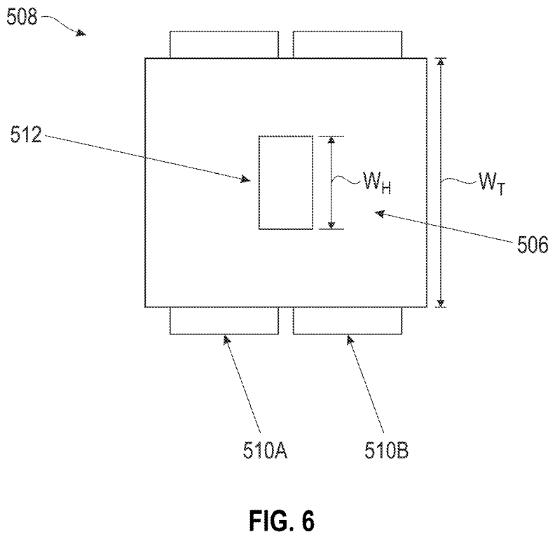

FIG. 6 illustrates a side view of the tape head module and tape guide assembly 508 of FIG. 5 taken at 6-6, in accordance with an embodiment of the disclosure. The tape head module 512 is narrower than the width of the tape 506. As shown, the tape 506 has a width indicated by W_{T}. The tape head module 512 has a width, indicated by W_{H}. In one embodiment, the ratio of the width of the tape head module 512 to the width of the tape 506 can be less than 1, or in a range from about 0.14 to about 0.55. W_{H} is less than W_{T}.

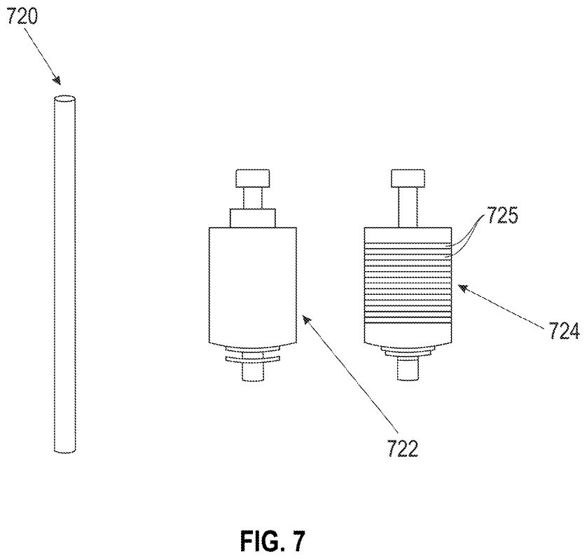

FIG. 7 illustrates perspective views of examples of guides, in accordance with an embodiment of the disclosure. A purpose of the guides is to provide an adequate span of tape over a tape head module. FIG. 7 includes a guidepost 720. It is a long cylindrically shaped guide. A tape can run over a smooth curved surface on the guidepost 720. The guidepost 720 can be a fixed or non-moveable pole. When tape is in motion an air bearing can be formed between the guidepost and the tape. The air bearing can ensure low friction between the tape and the guidepost 720. The guidepost 720 can have a high start-up friction with the tape though until the air bearing is formed. Compared to rollers, the guidepost 720 does not need bearings and, therefore, can be manufactured in smaller sizes. The guidepost 720 can alternatively have any suitable shape that provides a curved surface for tape to move over the guidepost while the remainder of the guidepost can have another shape.

FIG. 7 includes a guide roller 722 that includes a cylinder body that is mounted on ball bearings such that it can rotate. The guide roller 722 has a smooth surface and an air bearing can result when using the guide roller 722 in the tape drive 100 of FIG. 1, for example.

FIG. 7 also includes a guide roller 724 that includes a cylindrical-shaped body that include a plurality of grooves 725 that can suppress production of an air bearing. The cylindrical-shaped body of the guide roller 724 can be mounted on ball bearings such that it can rotate. A tape can continuously be in contact with the guide roller 724 and no air bearing may form if used in the tape drive 100, for example. The guide roller 724 with the grooves 725 can advantageously reduce or end compression wave disturbance. Due to the grooves 725, there may be negligible or no friction as long as the tape does not slip on the guide roller 724. There may be some friction in the bearings of the guide roller 724.

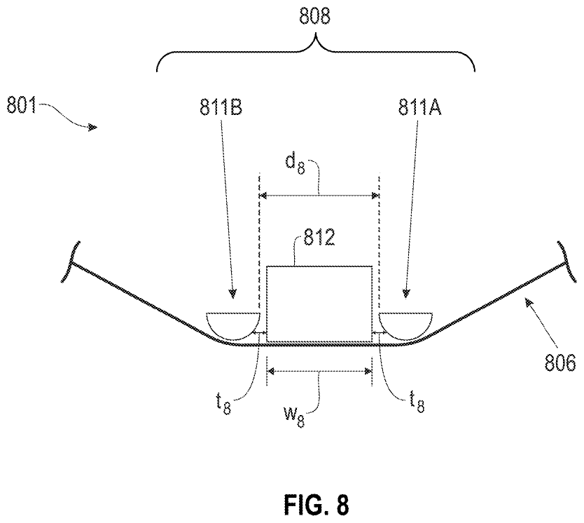

FIG. 8 illustrates a top view of a tape head module and tape guide assembly 808 (or “tape head and tape guide assembly”) of a portion of a tape drive 801 of a tape-based data storage system, in accordance with an embodiment of the disclosure. The tape head module and tape guide assembly 808 can include a first guide 811A (or “first tape support guide”) and a second guide 811B (or “second tape support guide”) that can be located on either side of a tape head module 812 (or “tape head”). The tape head module and tape guide assembly 808 includes front side guiding. The tape head module 812 (or head) can contain one or more write transducers used in tape recorders that can convert electrical signals to magnetic ones and one or more read transducers that can convert magnetic signals to electrical ones. The first and second guides 811A, 811B can be guideposts, as shown, which are stationary parts that include a curved surface to guide a tape 806 (or “tape media”) over the tape head module 812. The guideposts can be a smooth, polished lengthy part that is stationary, such as those shown in FIG. 8. The cross-sectional shape of the guideposts (first and second guides 811A, 8111B) shown is one example contemplated by the present disclosure to be used as guides. A suitable shape that includes a curved surface for the tape to move across can also be shaped in order to be placed in close proximity to the tape head module 812.

The first guide 811A and the second guide 811B guide can support the tape 806 as it moves across the tape head module 812. The location of the first guide 811A and the second guide 811B can be precisely set relative to the location of the tape head module 812. The tape 806 can move in either direction as it moves over the tape head module 812. The first guide 811A and the second guide 811B can be positioned closely to the tape head module 812 in order to ensure a short or stiff span of the tape 806 that can achieve a stable interface between the tape head module 812 and the tape 806.

The tape head module and tape guide assembly 808 is designed in order to minimize spacing between the tape head module 812 and the tape 806. The first guide 811A and the second guide 811B can minimize the spacing between the tape 806 and the tape head module 812 by providing a wrap angle of the tape 806 over the tape head module 812 in a range of 0.1 to 1.0 degrees, for example. The tape head module and tape guide assembly 808 is also designed in order to minimize the mass of the tape head module 812 and minimize the friction between the tape 806 and the tape head module 812.

The first guide 811A and the second guide 811B can be positioned closely to the tape head module 812 in order to ensure a short and stiff span of the tape 806 to achieve a stable interface between the tape 806 and the tape head module 812. The tape head module 812 can be located a distance away from the first guide 811A and the second guide 8111B, which can be called a “tolerance” (t₈). The tolerance is a space between the first guide 811A or the second guide 811B and the tape head module 812. As shown, d₈ is the distance between the first guide 811A and the second guide 811B. w₃ is the width of the tape head module 812. In the embodiment shown:

d₈−w₈+2t₈ (2)

In one embodiment, t₈ can be in a range of 0.1 mm to 1.0 mm. In another embodiment, t₈ can be in a range of 0.1 mm to 0.5 mm.

The tape head module 812 can be, for example, a magnetic tape head module that can include a plurality of arrays of data transducers. The tape head module 812 can be any suitable device that can read and/or write on tape media. The tape head module 812 (or “head” or “tape head” or “mini tape head module” or “mini module”) can contain one or more write transducers used in tape recorders that can convert electrical signals to magnetic ones and one or more read transducers that can convert magnetic signals to electrical signals. The tape head 812 can include, for example, three head modules, including two write transducer modules and one read transducer module. Each of these modules can contain one or more transducers.

The portion of the tape drive 801 as shown can be connected to other components (that are not shown), for example, such as those described with regard to the tape drive 100 in FIG. 1. The tape drive 100 in FIG. 1 is just one example, however, and other suitable tape drives are also contemplated by the present disclosure.

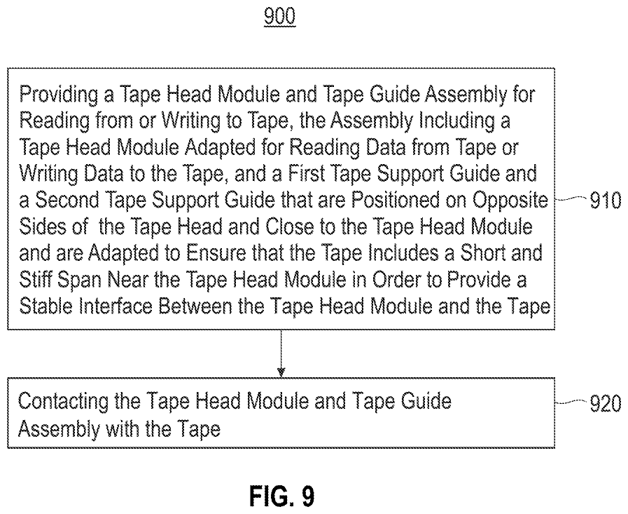

FIG. 9 is a flow diagram of a method 900, in accordance with an embodiment of the disclosure. One operation 910 is providing a tape head module and tape guide assembly for reading from or writing to tape, the assembly including a tape head adapted for reading data from the tape or writing data to the tape, and a first tape support guide and a second tape support guide that are positioned on opposite sides of the tape head and close to the tape head and are adapted to ensure that the tape includes a short and stiff span near the tape head in order to achieve a stable interface between the tape head and the tape. Another operation 920 is contacting the tape head module and tape guide assembly with the tape.

For purposes of this description, certain aspects, advantages, and novel features of the embodiments of this disclosure are described herein. The disclosed processes, and systems should not be construed as being limiting in any way. Instead, the present disclosure is directed toward all novel and nonobvious features and aspects of the various disclosed embodiments, alone and in various combinations and sub-combinations with one another. The processes, and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed processes can be used in conjunction with other processes. Additionally, the description sometimes uses terms like “provide” or “achieve” to describe the disclosed processes. These terms are high-level abstractions of the actual operations that are performed. The actual operations that correspond to these terms can vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.”

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A tape head module and tape guide assembly, the assembly comprising:
a tape head module that is adapted for reading data from tape or writing data to the tape; and
a first tape support guide and a second tape support guide that are positioned on opposite sides of the tape head module and in close proximity to the tape head module and adapted to provide a short and stiff portion of the tape located near the tape head module and provide a stable interface between the tape head module and the tape.

2. The assembly of claim 1, wherein a width of the tape head module is less than a width of the tape.

3. The assembly of claim 1, wherein the first tape support guide and the second tape support guide are guide rollers.

4. The assembly of claim 1, wherein a distance between the first tape support guide and the second tape support guide is in a range of 0.1 millimeter to 1 millimeter.

5. The assembly of claim 1, wherein the first tape support guide and the second tape support guide are guideposts.

6. The assembly of claim 1, wherein a width of the tape head module is less than a width of the tape.

7. A tape head module and tape guide assembly, the assembly comprising:
a tape head module that is adapted for reading data from tape or writing data to the tape; and
a first tape support guide and a second tape support guide that are positioned on an opposite side of the tape from the tape head module and in close proximity to each other and adapted to provide a short and stiff portion of the tape located near the tape head module and provide a stable interface between the tape head module and the tape.

8. The assembly of claim 7, wherein a width of the tape head module is less than a width of the tape.

9. The assembly of claim 7, wherein the first tape support guide and the second tape support guide are guide rollers.

10. The assembly of claim 7, wherein the first tape support guide and the second tape support guide are guideposts.

11. The assembly of claim 7, wherein a width of the tape head module is less than a width of the tape.

12. The assembly of claim 7, wherein a distance between the first tape support guide and the second tape support guide is in a range of 0.1 millimeter to 1 millimeter.

13. A tape drive system comprising:
a tape media adapted to store data;
at least one reel adapted to unroll the tape media therefrom or roll the tape media thereto;
a tape head module and tape guide assembly for reading from or writing to the tape media including:
a tape head module adapted for reading data from the tape media or writing data to the tape media, and
a first tape support guide and a second tape support guide that are positioned on opposite sides of the tape head module and in close proximity to the tape head module and adapted to provide a short and stiff portion of the tape media located near the tape head module and provide a stable interface between the tape head module and the tape media; and
a plurality of rollers rotatable about an axis and adapted to move the tape media past the tape head module and tape guide assembly.

14. The tape drive system of claim 13, wherein a width of the tape head module is less than a width of the tape media.

15. The tape drive system of claim 13, wherein the first support guide and the second tape support guide are guide rollers.

16. The tape drive system of claim 15, wherein the rollers of the first support guide and the second tape support guide include grooves adapted to reduce air bearing formation.

17. The tape drive system of claim 13, wherein the first tape support guide and the second tape support guide are guideposts.

18. The tape drive system of claim 13, wherein the first tape support guide and the second tape support guide are located on an opposite side of the tape media from the tape head module.

19. The tape drive system of claim 13, wherein the first tape support guide and the second tape support guide that are positioned on opposite sides of the tape head module.

20. The tape drive system of claim 13, wherein a distance between the first tape support guide and the second tape support guide is in a range of 0.1 millimeter to 1 millimeter.
